(19) United States
(12) Patent Application Publication
(10) Pub. No.: US 2020/0048004 A1
(43) Pub. Date: Feb. 13, 2020

(54) MATERIAL HANDLING SYSTEM AND METHOD

(71) Applicant: Dematic Corp., Grand Rapids, MI (US)

(72) Inventors: William R. Boer, Grand Rapids, MI (US); Anthony W. Hasman, Howard City, MI (US)

(21) Appl. No.: 16/535,869

(22) Filed: Aug. 8, 2019

Related U.S. Application Data
(60) Provisional application No. 62/716,528, filed on Aug. 9, 2018.

(51) Int. Cl. B65G 1/137

(52) U.S. Cl. CPC B65G 1/1375

(57) ABSTRACT

A material handling system and method of arranging articles, includes storing articles in an automated storage and retrieval system having a rack system with multiple levels, some of the multiple levels defining storage shelves and an aisle between storage shelves at the level. Articles are stored to and retrieved from the storage shelve at opposite sides of an aisle with a plurality of shuttles, each at the aisle at one of the levels. Elevation of an article is changed to one of the levels with a first of a plurality of article lifts supported by the rack system for storage by one of the shuttles. Elevation of an article that is retrieved by one of said shuttles at one of the levels is changed with the first of a plurality of article lifts. Articles are retrieved from the first of the article lifts in a first sequence of articles with a sequencer. The sequencer includes at least a second of the article lifts, a third of the article lifts, and a conveying surface supported by the rack system. Elevation of articles is changed to the conveying surface with the second of the article lifts and elevation of articles is changed from the conveying surface in the second sequence of articles with the third of the article lifts.

### CROSS REFERENCE TO RELATED APPLICATION

The present application claims priority of U.S. provisional application Ser. No. 62/716,528 filed Aug. 9, 2018, which is hereby incorporated herein by reference in its entirety.

### BACKGROUND AND FIELD OF THE INVENTION

The present invention is directed to a material handling system and method of arranging articles in a manner that palletizes the articles for supplying to a retail establishment. It is known to receive articles in pallets of identical articles and automatically arrange the articles on outgoing pallets which are wrapped for supply to a particular retail establishment. It is known to even build the pallet for a particular aisle in the establishment, such as baby supplies, cereal, or the like, in order to minimize the labor needed to stock the shelves of the retail establishment.

There are many problems associated with the above. With retail establishments adopting multiple different types of store formats such as convenience stores, full service stores, and the like, the need for the material handling system to handle an ever larger number of product codes, or stock keeping units (SKU) places ever demanding flexibility on the system. Of course such flexibility cannot be achieved in a manner that sacrifices system speed or throughput.

### SUMMARY OF THE INVENTION

The present invention provides a material handling system and method of arranging articles in a manner that is capable of handling a large number of SKUs in a fast and flexible manner. This is accomplished by decoupling the article storage and sequencing function. Also, the system is capable of compact configuration which reduces material transportation distances, which also increases system speed and throughput. The compact configuration also reduces required size of the warehouse, which reduces building costs.

A material handling system and method of arranging articles, according to an aspect of the invention, includes storing articles in an automated storage and retrieval system, having a rack system with multiple levels, some of the multiple levels defining storage shelves and an aisle between storage shelves at the level. Articles are stored to and retrieved from the storage shelve at opposite sides of an aisle with a plurality of shuttles, each at the aisle at one of the levels. Elevation of an article is changed to one of the levels with a first of a plurality of article lifts supported by the rack system for storage by one of the shuttles. Elevation of an article that is retrieved by one of said shuttles at one of the levels is changed with the first of a plurality of article lifts. Articles are retrieved from the first of the article lifts in a first sequence of articles with a sequencer. The sequencer includes at least a second of the article lifts, a third of the article lifts, and a conveying surface supported by the rack system. Elevation of articles is changed to the conveying surface with the second of the article lifts and elevation of articles is changed from the conveying surface in the second sequence of articles with the third of the article lifts.

The conveying surface of the sequencer may include a plurality of vertically arranged conveying surfaces and second of the article lifts changes elevation of articles of the first sequence of articles to the conveying surfaces, and the third of the article lifts changes elevation of articles from the conveying surfaces in a manner that arranges the first sequence of articles to the second sequence of articles. A plurality sequencers may be provide, each having a second of the article lifts, a third of the article lifts, and a conveying surface supported by the rack system and the automated storage and retrieval system have a plurality of aisles each having a plurality of shuttles and a first of the article lifts. Articles are transported with a transport system from one of the first of the article lifts to one of the second of the article lifts.

The transport system may be a sorter that sorts articles from one of the first of the article lifts to one of the second article lifts. The sorter may be a carousel sorter such as a cross-belt sorter, a tilt-tray sorter, or the like. A pallet of articles may be received with at least one de-palletizer. Individual articles may be removed from the pallet and loaded to the sorter with the at least one de-palletizer, and discharged from the sorter to one of the first of said article lifts for storage at the storage shelves. The transport system may occupy of one of the levels of the rack system. The sorter may be routed between the first of the article lifts and the plurality of sequences. A plurality of article palletizers including supplying second sequence of articles from said third of said article lifts to one of said article palletizers.

A traying system may be provided to place articles on trays for storage in the automated storage and retrieval system and a de-traying system provided for separating articles from trays prior to the sequencer. The automated storage and retrieval system may be adapted to receive full case articles and the sequencer also adapted to receive mixed-case articles.

These and other objects, advantages and features of this invention will become apparent upon review of the following specification in conjunction with the drawings.

### BRIEF DESCRIPTION OF THE DRAWINGS

FIG. 1 is a block diagram of a material handling system and method of arranging articles according to an embodiment of the invention;

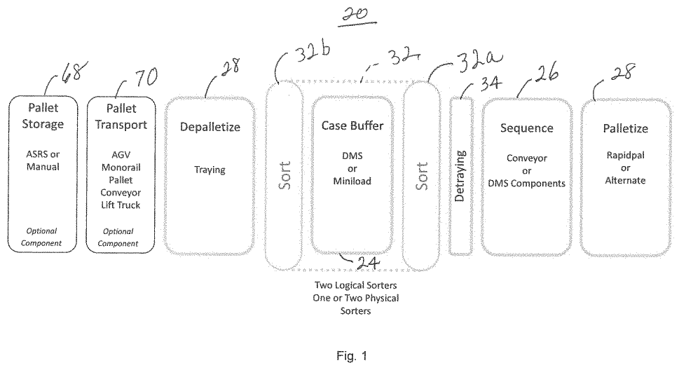

FIG. 2 is a top plan view of a material handling system layout:

FIG. 3 is a side elevation of a sequencer;

FIG. 4 is a perspective view of a material handling system according to an embodiment of the invention;

FIG. 5 is the same view as FIG. 4 of an alternative embodiment of the invention;

FIG. 6 is a top plan view of the material handling system in FIG. 5;

FIG. 7 is the same view as FIG. 6 with the rack system removed; and

FIG. 8 is a perspective view of the portion of the material handling system in FIG. 7.

### DESCRIPTION OF THE PREFERRED EMBODIMENTS

Referring now to the drawings and the illustrative embodiment depicted therein, a material handling system 22 and method of arranging articles 20 includes storing articles in an automated storage and retrieval system 24 having a rack system 42 with multiple levels 48. Some of the multiple levels defining storage shelves 46 with an aisle 44 between storage shelves at the level. Articles are stored to and retrieved from the storage shelve 46 at opposite sides of an aisle 44 with a plurality of shuttles (not shown), each at the aisle at one of the levels. Each shuttle may be of the type disclosed in commonly assigned U.S. Pat. No. 9,522,781, the disclosure of which is hereby incorporated herein by reference. The shuttle is capable of storing articles double deep on the storage shelve, as disclosed in commonly assigned U.S. Pat. No. 8,790,061, the disclosure of which is hereby incorporated herein by reference, or even triple deep.

Elevation of an article is changed to one of levels 48 with a first of a plurality of article lifts 50 that are supported by the rack system 42 for storage by one of the shuttles. Conversely, elevation of an article that is retrieved by one of the shuttles at one of the levels 48 is changed with the first of a plurality of article lifts 50. Articles are retrieved from the first of the article lifts in a first sequence of articles with a sequencer 26. The first sequence of articles is a result of retrieving the articles in the fastest and most efficient manner by article lifts 50 and therefore is not in any planned order. The sequencer 26 includes at least a second of the article lifts 52, a third of the article lifts 54, and a conveying surface 56, all supported by the rack system 42. Within sequencer 26, elevation of articles is changed to the conveying surface 56 with the second of the article lifts 52 and elevation of articles is changed from the conveying surface in a second sequence of articles with the third of the article lifts 54. Article lifts 50, 52, and 54 may be provided according to commonly assigned U.S. Pat. No. 9,266,675, the disclosure of which is hereby incorporated herein by reference. The second sequence of articles is a desired arrangement that is planned in order to be most compatible with a palletizer 28. The second sequence of articles may be planned in order to place heavier more stable articles in a lower position on the pallet, for example, or in a sequence according to a location within the retail establishment.

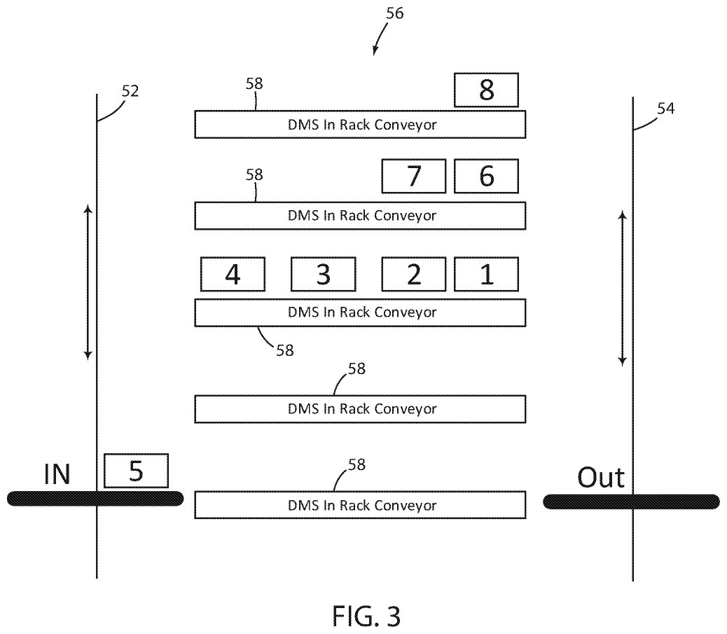

The conveying surface 56 of the sequencer 26 includes a plurality of vertically arranged conveying surfaces 58 and second of the article lifts 52 changes elevation of articles of the first sequence of articles to the conveying surfaces 52 in a manner that arranges the articles on each conveying surface sequentially. The third of the article lifts 54 retrieves and changes elevation of articles from the conveying surfaces 58 in a manner that arranges the first sequence of articles to the second sequence of articles by discharging articles selectively from the conveying surfaces 58 as will be understood by the skilled artisan and as illustrated in FIG. 3. Other sequencing schemes are possible.

A plurality sequencers 26 are provided, each having a second of article lifts 52, a third of article lifts 54 and a conveying surface 56 supported by the rack system 42. Automated storage and retrieval system 24 has a plurality of aisles 44 each having a plurality of shuttles and a first of said article lifts 50. Articles are transported with a transport system 40 from one of the first of the article lifts 50, to one of the second of the article lifts 52, and from one of the third of the article lifts 54 to one of a plurality of palletizers.

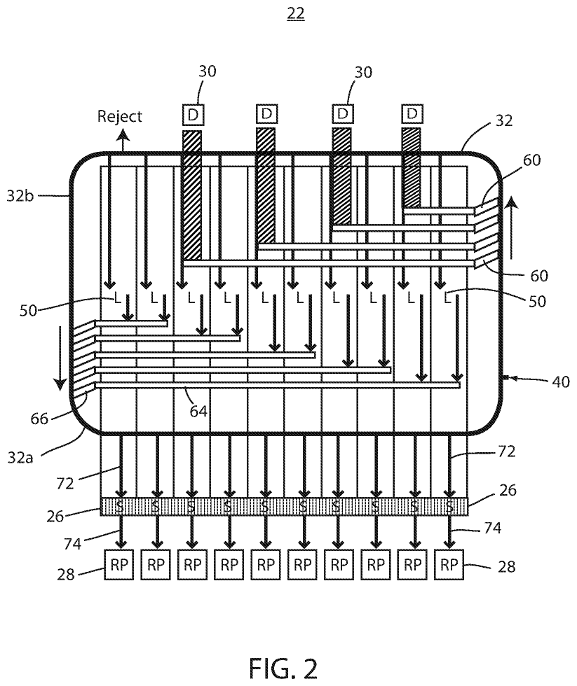

The transport system 40 may be a sorter 32a that sorts articles from one of the first of the article lifts 50 to one of the second article lifts 52. The sorter 32a may be a logical sorter portion along with a logical sorter portion 32b that are defined by a carousel sorter 32, such as a cross-belt sorter, a tilt-tray sorter, or the like. A pallet of articles may be received with at least one de-palletizer 30. Individual articles may be removed from the pallet and loaded to sorter 32b with the at least one de-palletizer 30 and discharged from the sorter 32b to one of the first of said article lifts 50 for storage at the storage shelves 46 of automated storage and retrieval system 24. The transport system may occupy of one of the levels of the rack system as best illustrated in FIG. 2, in which the upper shelves are removed to show the level dedicated to the transport system 40. Each de-palletizer 30 removes articles from a load and loads the articles to a tray. The tray (not shown) has a bar code, RFID tag or other means to identify the tray and to associate it with the article being carried by the tray. The tray with the article is transported via transport system 40 to an induct 60 of sorter 32. After induct 60 loads the article to sorter 32, the article is discharged to one of discharge lanes 62 of the transport system associated with one of the first article lift 50 for transport to the first article lift. In this manner, any de-palletizer can direct an article to any first of the article lifts 50 to provide flexibility in directing the article to any aisle 44 of the automated storage and retrieval system.

When an article is requested by a warehouse management system (not shown) for inclusion on a pallet load, the article is retrieved by the shuttle for the associated aisle 44 and lowered (or raised) by first article lift 50 to the level of transport system 40. The article is transported by a discharge lane 64 of transport system 40 to an induct 66 of sorter 32. In order to speed up the feed of the articles to sorter 32, discharge lane 64 is conveyor without any buffering. In this manner, articles are loaded to sorter 32 in the order that they arrive at induct 66 which is likely different from the order in which they are required for building the pallet by palletizer 28. From sorter 32a, the articles are discharged in the first sequence of articles required by the palletizer on a discharge 72 and pass through a detraying system 34 for removal of the tray. From there the articles are routed to sequencer 26 where the articles arrive in the second sequence of articles as previously described and fed to the palletizer via a discharge 74. In the illustrated embodiment, the traying and detraying systems are of the type disclosed in Published Patent Application No. US2013/0062160, the disclosure of which is hereby incorporated herein by reference. However, other traying systems may be used.

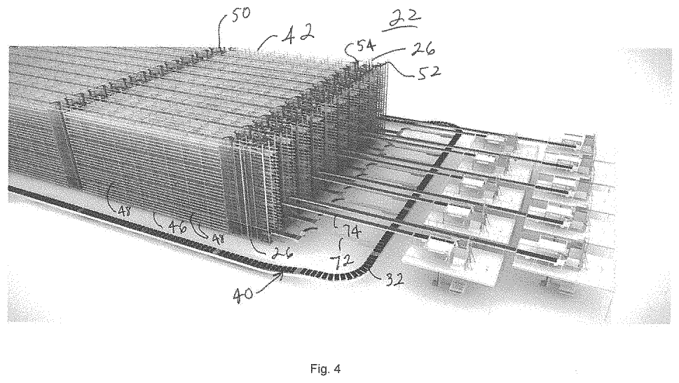

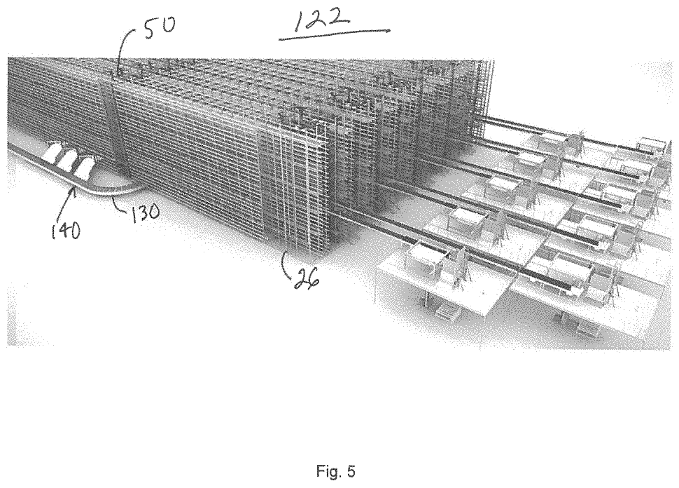

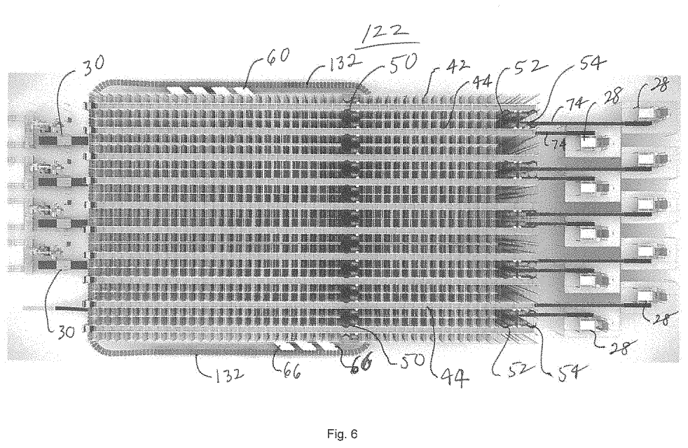

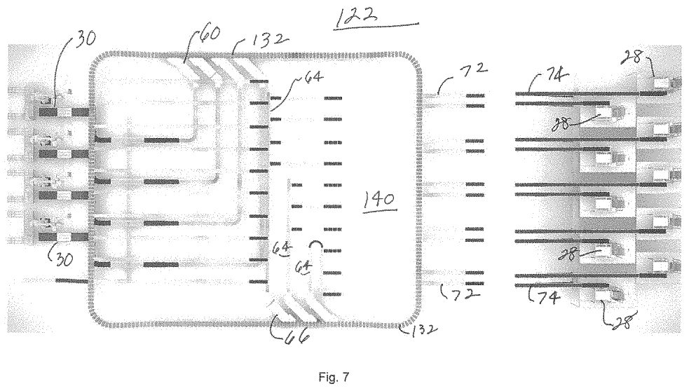

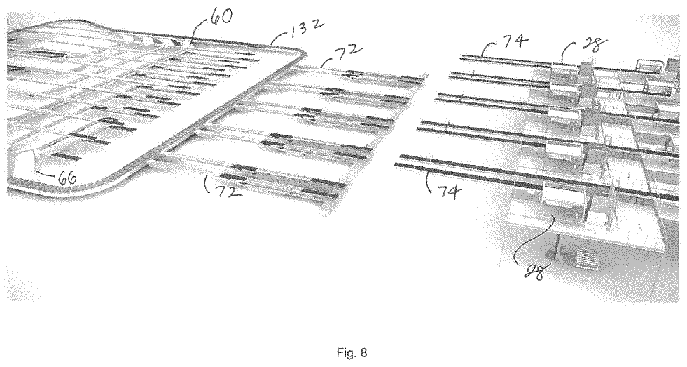

Alternative pallet handling equipment may be provided such as an automated pallet storage system 68 and a pallet transport system 70, such as a monorail, conveyor, or lift truck to transport full pallets to a de-palletizer 30. In material handling system 22 as illustrated in FIG. 4, sorter 32, and in particular logical sorter 32a is routed between sequencers 26 and palletizers 28. In an alternative embodiment, shown in FIGS. 5 through 8, a material handling system 122 has a transport system 140, in which sorter 130 is routed between the first of the article lifts 50 and the plurality of sequencers 26. This configuration allows the palletizers 28 to be closer to sequencers 26 which reduces the overall footprint of the system 122. Otherwise the systems 22 and 122 are essentially identical. Palletizer 28 may be according to commonly assigned U.S. Pat. No. 9,315,337, the disclosure of which is hereby incorporated herein by reference.

While the method and system are shown for arranging articles in the form of full cases, sorter 32 and sequencer 26 may also be adapted to receive mixed-case articles and load the mixed-case articles with palletizer 28 to a pallet load. This makes the method and system more flexible.

The embodiments of the invention in which an exclusive property or privilege is claimed are defined as follows:

1. A material handling system, comprising:
an automated storage and retrieval system comprising a rack system having multiple levels, some of said multiple levels defining storage shelves and an aisle between storage shelves at least said level;
a plurality of shuttles, each at said aisle at one of said levels and adapted to store articles to and retrieve articles from the storage shelves at opposite lateral sides said aisle;
a plurality of article lifts supported at said rack system;
at least a first of said article lifts adapted to change elevation of an article to one of said levels for storage of the article by one of said shuttles and to change elevation of an article retrieved by one of said shuttles at one of said levels;
a sequencer adapted to arrange articles received from said first of said article lifts from a first sequence of articles to a second sequence of articles, said sequencer comprising at least a second of said article lifts, a third of said article lifts and a conveying surface supported by said rack system, said second of said article lifts adapted to change elevation of articles to said conveying surface in the first sequence of articles and said third of said articles lifts adapted to change elevation of articles from said conveying surface in the second sequence of articles.

2. The material handling system as claimed in claim 1, wherein said conveying surface comprises a plurality of vertically arranged conveying surfaces, wherein said second of said article lifts is adapted to change elevation of articles of the first sequence of articles to said conveying surfaces and said third of said article lifts is adapted to change elevation of articles from said conveying surfaces in a manner that arranges the first sequence of articles to the second sequence of articles.

3. The material handling system as claimed in claim 1 including a plurality sequencers each having a second of said article lifts, a third of said article lifts and a conveying surface supported by said rack system and wherein said automated storage and retrieval system comprise a plurality of aisles each having a plurality of shuttles and a first of said article lifts and including a transport system that is adapted to transport articles from one of said first of said article lifts to one of said second of said article lifts.

4. The material handling system as claimed in claim 3, wherein said transport system comprises a sorter that is adapted to sort articles from one of said first of said article lifts to one of said second article lifts.

5. The material handling system as claimed in claim 4, wherein said sorter comprises a carousel sorter.

6. The material handling system as claimed in claim 4 including at least one de-palletizer that is adapted to receive a pallet of articles and remove individual articles from the pallet and loads the individual articles to the sorter and wherein said sorter is adapted to discharge one of said first of said article lifts for storage at the storage shelves.

7. The material handling system as claimed in claim 3, wherein said transport system occupies of one of said levels of said rack system.

8. The material handling system as claimed in claim 4, wherein said sorter is routed between said first of said article lifts and said plurality of sequences.

9. The material handling system as claimed in claim 1 including a plurality of article palletizers and wherein said third of said article lifts supplies articles in the second sequence of articles to one of said article palletizers.

10. A method of arranging articles, said method comprising:
storing articles in an automated storage and retrieval system comprising a rack system having multiple levels, some of said multiple levels defining storage shelves and an aisle between storage shelves at least said level;
storing articles to and retrieving articles from the storage shelve at opposite sides of an aisle with a plurality of shuttles, each at said aisle at one of said levels;
changing elevation of an article to one of said levels with a first of a plurality of article lifts supported by said rack system for storage by one of said shuttles and changing elevation of an article retrieved by one of said shuttles at one of said levels with said first of a plurality of article lifts;
receiving articles from said first of said article lifts in a first sequence of articles with a sequencer, said sequencer comprising at least a second of said article lifts, a third of said article lifts and a conveying surface supported by said rack system, including changing elevation of articles to said conveying surface with said second of said article lifts and changing elevation of articles from said conveying surface in the second sequence of articles with said third of said article lifts.

11. The arranging articles s claimed in claim 10, wherein said conveying surface comprises a plurality of vertically arranged conveying surfaces, wherein said second of said article lifts changes elevation of articles of the first sequence of articles to said conveying surfaces and said third of said article lifts changes elevation of articles from said conveying surfaces in a manner that arranges the first sequence of articles to the second sequence of articles.

12. The arranging of articles as claimed in claim 10 including a plurality sequencers each having a second of said article lifts, a third of said article lifts and a conveying surface supported by said rack system and wherein said automated storage and retrieval system comprise a plurality of aisles each having a plurality of shuttles and a first of said article lifts and including transporting articles with a transport system from one of said first of said article lifts to one of said second of said article lifts.

13. The arranging of articles as claimed in claim 12, wherein said transport system comprises a sorter including sorting articles from one of said first of said article lifts to one of said second article lifts with said sorter.

14. The arranging of articles as claimed in claim 13, wherein said sorter comprises a carousel sorter.

15. The arranging of articles as claimed in claim 13 including receiving a pallet of articles with at least one de-palletizer and removing individual articles from the pallet and loading the individual articles to the sorter with the at least one de-palletizer and discharging articles from the sorter to one of said first of said article lifts for storage at the storage shelves.

16. The arranging of articles as claimed in claim 12, wherein said transport system occupies of one of said levels of said rack system.

17. The arranging of articles as claimed in claim 12, wherein said sorter is routed between said first of said article lifts and said plurality of sequences.

18. The arranging of articles as claimed in claim 10 including a plurality of article palletizers including supplying second sequence of articles from said third of said article lifts to one of said article palletizers.

19. The arranging of articles as claimed in claim 10 including a traying system including placing articles on trays for storage in said automated storage and retrieval system and a de-traying system including separating articles from trays prior to said sequencer.

20. The arranging of articles as claimed in claim 10 including receiving full cases of articles with said automated storage and retrieval system and also receiving mixed-case articles with said sequencer.
